(19) United States
(12) Patent Application Publication
(10) Pub. No.: US 2022/0353579 A1
(43) Pub. Date: Nov. 3, 2022

(54) SYSTEM AND METHOD FOR SOCIAL MEDIA-BASED CONTENT RECOMMENDATIONS

(71) Applicant: Caavo Inc, Milpitas, CA (US)

(72) Inventors: Ashish D. Aggarwal, Stevenson Ranch, CA (US); Andrew E. Einaudi, Scotts Valley, CA (US)

(21) Appl. No.: 17/865,818

(22) Filed: Jul. 15, 2022

Related U.S. Application Data
(63) Continuation of application No. 16/589,889, filed on Oct. 1, 2019.
(60) Provisional application No. 62/739,590, filed on Oct. 1, 2018.

(51) Int. Cl. H04N 21/466; H04L 67/306; H04N 21/472; H04N 21/45; H04N 21/442; H04L 51/52; H04L 61/45; H04L 67/50

(52) U.S. Cl. CPC H04N 21/4667; H04L 67/306; H04N 21/47217; H04N 21/4532; H04N 21/44204; H04N 21/44226; H04L 51/52; H04L 61/4547; H04L 67/535

(57) ABSTRACT

Methods, systems, and computer program products are provided for recommending content based on content being engaged with by a user's social media contacts. For example, embodiments described herein advantageously provide a user with content recommendations that are based on what other people associated with the user (e.g., via a social media service) are consuming. For instance, content being engaged with by a user's social media contacts are monitored via multimedia devices utilized by the user and his contacts and/or are inferred via social media posts of the user's contacts. Once the content is determined, the user is provided with recommendations for that contact. The recommendations may be provided to the user while the user is watching content and/or browsing for content. The recommendations may also be provided based on periodicity of the media content.

### CROSS-REFERENCE TO RELATED APPLICATIONS

This application is a continuation of U.S. application Ser. No. 16/589,889, filed Oct. 1, 2019, titled “System and Method for Social Media-Based Content Recommendations,” which claims priority to U.S. Provisional Patent Application No. 62/739,590, titled “System and Method for Social Media-Based Content Recommendations,” filed Oct. 1, 2018, the entireties of which are incorporated by reference herein.

### BACKGROUND

### Technical Field

The present subject matter relates to making recommendations of media content to users based on social media services associated therewith.

### Background Art

Media content choices, such as movies, music, television programs, and videos, are ever-increasing. The sheer quantity of choices can often leave a viewer with a feeling of nothing to watch, even though there are now hundreds of television channels and an unlimited number of viral videos that may be selected for viewing, such as when browsing Internet videos. Often, a viewer may only have a limited amount of time to devote to watching television and/or browsing videos, yet is left to determine and prioritize what to select for viewing from the many choices. Viewers would likely prefer not to waste a limited amount of viewing time searching for something to watch, or watching video content that is irrelevant or otherwise not of interest to them.

### BRIEF SUMMARY

Methods, systems, and apparatuses are described for social media-based content recommendations, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for recommending content based on content being engaged with by a user's social media contacts, according to an example embodiment.

FIG. 2 shows a flowchart of an example process for recommending content based on content being engaged with by a user's social media contacts, according to an example embodiment.

FIG. 3 shows a system for recommending content based on content being engaged with by a user's social media contacts, according to another example embodiment.

FIG. 4 shows a system for recommending content based on content being engaged with by a user's social media contacts in accordance with yet another example embodiment.

FIG. 5 depicts a flowchart of an example process for determining that users are associated with each other via a social media service, according to an example embodiment.

FIG. 6 shows a system for determining that users are associated with each other a via social media service, according to an example embodiment.

FIG. 7 depicts a flowchart of an example process for determining a particular piece of media content in which a user is engaging via a social media service, according to an example embodiment.

FIG. 8 shows a system for determining a particular piece of media content in which a user is engaging via a social media service, according to an example embodiment.

FIG. 9 shows a system for determining a particular piece of media content in which a user is engaging via a social media service, according to another example embodiment.

FIG. 10 is a block diagram of an example processor-based computer system that may be used to implement various embodiments.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Still further, it should be noted that the drawings/figures are not drawn to scale unless otherwise noted herein.

Numerous exemplary embodiments are now described. Any section/subsection headings provided herein are not intended to be limiting. Embodiments are described throughout this document, and any type of embodiment may be included under any section/subsection. Furthermore, it is contemplated that the disclosed embodiments may be combined with each other in any manner. That is, the embodiments described herein are not mutually exclusive of each other and may be practiced and/or implemented alone, or in any combination.

A method for recommending content to a first user is described herein. The method comprises: determining that the first user utilizes a first multimedia device to consume media content; determining that a second user, which utilizes a second multimedia device to consume media content, is associated with the first user via a social media service; determining that the second user is consuming a particular piece of media content via the second multimedia device; and causing an indicator to be displayed via a graphical user interface rendered on a display device communicatively coupled to the first multimedia device responsive to determining that the second user consuming the particular piece of media content is associated with the first user, the indicator recommending the particular piece of media content to the first user.

In one embodiment of the foregoing method, determining that a second user that utilizes a second multimedia device to consume media content is associated with the first user via a social media service comprises: receiving, via the first device, social media user credentials associated with the first user; accessing a social media profile associated with the first user based on the social media credentials; determining that the social media profile indicates that the second user is a contact of the first user; and determining that the second user is associated with the first user based on determining that the social media profile indicates that the second user is a contact of the first user.

In one embodiment of the foregoing method, determining that the second user is consuming a particular piece of media content via the second multimedia device comprises: receiving one or more social media posts of the second user based on the social media credentials associated with the first user; and analyzing the one or more social media posts for media content identifiers that identify the particular piece of media content in which the second user is engaging.

In one embodiment of the foregoing method, determining that the second user is consuming a particular piece of media content via the second multimedia device comprises: receiving a communication message from the second device that identifies the particular piece of media content.

In one embodiment of the foregoing method, determining that the second user is consuming the particular piece of media content comprises: determining that the second user is consuming the particular piece of media content during at least one of a particular day or a particular time; and said causing comprises: causing the indicator to be displayed via the graphical user interface rendered on the display device based on the at least one of the particular day or the particular time.

In one embodiment of the foregoing method, said causing comprises: determining that the first user is browsing for media content to engage via the graphical user interface of the first device; and causing the indicator to be displayed via the graphical user interface in response to determining that the first user is browsing for the media content.

In one embodiment of the foregoing method, the method further comprises: causing a user-interactive element to be displayed via the graphical user interface that, when activated, causes the particular piece of media content to be played back via the first device.

A system is also described herein. The system comprises at least one processor circuit; and at least one memory that stores program code configured to be executed by the at least one processor circuit, the program code comprising: a device determiner configured to determine that the first user utilizes a first multimedia device to consume media content; a user associator configured to determine that a second user, which utilizes a second multimedia device to consume media content, is associated with the first user via a social media service; a content observer configured to determine that the second user is consuming a particular piece of media content via the second multimedia device; and a content recommender configured to cause an indicator to be displayed via a graphical user interface rendered on a display device communicatively coupled to the first multimedia device responsive to determining that the second user consuming the particular piece of media content is associated with the first user, the indicator recommending the particular piece of media content to the first user.

In one embodiment of the foregoing system, the user associator is further configured to: receive, via the first device, social media user credentials associated with the first user; access a social media profile associated with the first user based on the social media credentials; determine that the social media profile indicates that the second user is a contact of the first user; and determine that the second user is associated with the first user based on determining that the social media profile indicates that the second user is a contact of the first user.

In one embodiment of the foregoing system, the content observer is further configured to: receive one or more social media posts of the second user based on the social media credentials associated with the first user; and analyze the one or more social media posts for media content identifiers that identify the particular piece of media content in which the second user is engaging.

In one embodiment of the foregoing system, the content observer is further configured to: receive a communication message from the second device that identifies the particular piece of media content.

In one embodiment of the foregoing system, the content observer is further configured to: determine that the second user is consuming the particular piece of media content during at least one of a particular day or a particular time; and the content recommender is further configured to: cause the indicator to be displayed via the graphical user interface rendered on the display device based on the at least one of the particular day or the particular time.

In one embodiment of the foregoing system, the content recommender is further configured to: determine that the first user is browsing for media content to engage via the graphical user interface of the first device; and cause the indicator to be displayed via the graphical user interface in response to determining that the first user is browsing for the media content.

In one embodiment of the foregoing system, the content recommender is further configured to cause a user-interactive element to be displayed via the graphical user interface that, when activated, causes the particular piece of media content to be played back via the first device.

A computer-readable storage medium having program instructions recorded thereon that, when executed by at least one processor of a computing device, perform a method, the method comprising: determining that the first user utilizes a first multimedia device to consume media content; determining that a second user, which utilizes a second multimedia device to consume media content, is associated with the first user via a social media service; determining that the second user is consuming a particular piece of media content via the second multimedia device; and causing an indicator to be displayed via a graphical user interface rendered on a display device communicatively coupled to the first multimedia device responsive to determining that the second user consuming the particular piece of media content is associated with the first user, the indicator recommending the particular piece of media content to the first user.

In one embodiment of the foregoing computer-readable storage medium, determining that a second user that utilizes a second multimedia device to consume media content is associated with the first user via a social media service comprises: receiving, via the first device, social media user credentials associated with the first user; accessing a social media profile associated with the first user based on the social media credentials; determining that the social media profile indicates that the second user is a contact of the first user; and determining that the second user is associated with the first user based on determining that the social media profile indicates that the second user is a contact of the first user.

In one embodiment of the foregoing computer-readable storage medium, determining that the second user is consuming a particular piece of media content via the second multimedia device comprises: receiving one or more social media posts of the second user based on the social media credentials associated with the first user; and analyzing the one or more social media posts for media content identifiers that identify the particular piece of media content in which the second user is engaging.

In one embodiment of the foregoing computer-readable storage medium, determining that the second user is consuming a particular piece of media content via the second multimedia device comprises: receiving a communication message from the second device that identifies the particular piece of media content.

In one embodiment of the foregoing computer-readable storage medium, determining that the second user is consuming the particular piece of media content comprises: determining that the second user is consuming the particular piece of media content during at least one of a particular day or a particular time; and said causing comprises: causing the indicator to be displayed via the graphical user interface rendered on the display device based on the at least one of the particular day or the particular time.

In one embodiment of the foregoing computer-readable storage medium, said causing comprises: determining that the first user is browsing for media content to engage via the graphical user interface of the first device; and causing the indicator to be displayed via the graphical user interface in response to determining that the first user is browsing for the media content.

### II. Example Embodiments

Embodiments described herein are configured in various ways to recommend content based on content being engaged with by a user's social media contacts. For example, embodiments described herein advantageously provide a user with content recommendations that are based on what other people associated with the user (e.g., via a social media service) are consuming or have consumed. For instance, content being engaged with by a user's social media contacts are monitored via multimedia devices utilized by the user and his contacts and/or are inferred via social media posts of the user's contacts. Once the content is determined, the user is provided with recommendations for that content. The recommendations may be provided to the user while the user is watching content and/or browsing for content. The recommendations may also be provided based on periodicity of the media content.

The embodiments described herein may be adapted to various types of systems and devices, for example but without limitation, communication devices (e.g., cellular and smart phones, etc.), computers/computing devices (e.g., laptops, tablets, desktops, etc.), computing systems, electronic devices, gaming consoles, home electronics and entertainment devices (e.g., home theater systems, stereos, televisions, audio/video (A/V) switching devices, etc.), and/or the like. It is contemplated herein that in various embodiments and with respect to the illustrated figures of this disclosure, one or more components described and/or shown may not be included and that additional components may be included.

Embodiments described herein advantageously reduce the clutter of user interface (UI) elements such as graphical UI (GUI) elements presented to a user for content selection/recommendation by reducing the number of GUI elements presented to a user for content recommendations, thereby providing a user with a minimal, simplified GUI that automatically navigates a user through a normally cluttered, complex or confusing GUI. The reduction in clutter is possible by presenting a relatively lower number of determined recommendations based on the techniques described herein.

Embodiments described herein can improve the functioning of a system or a device (e.g., a computer or processing device) on which they are implemented. For example, content recommendations made according to the described embodiments allow for the simplification elements presented by a UI, e.g., a relatively small number of desired recommendations based on a usage profile. Thus, systems and devices perform more efficiently by providing content faster and using less power (less menu browsing and manual programming by the user, etc.). Additionally, the overall user experience is improved.

Various example embodiments are described in herein. In particular, example usage profile embodiments are described. This description is followed by further example embodiments and advantages. Subsequently an example processing device implementation is described. Finally, some concluding remarks are provided. It is noted that any division of the description herein generally into subsections and/or embodiments is provided for ease of illustration, and it is to be understood that any type of embodiment may be described in any subsection.

### III. Example Embodiments

Systems and devices may be configured in various ways to recommend content based on content being engaged with by a user's social media contacts, according to the embodiments provided.

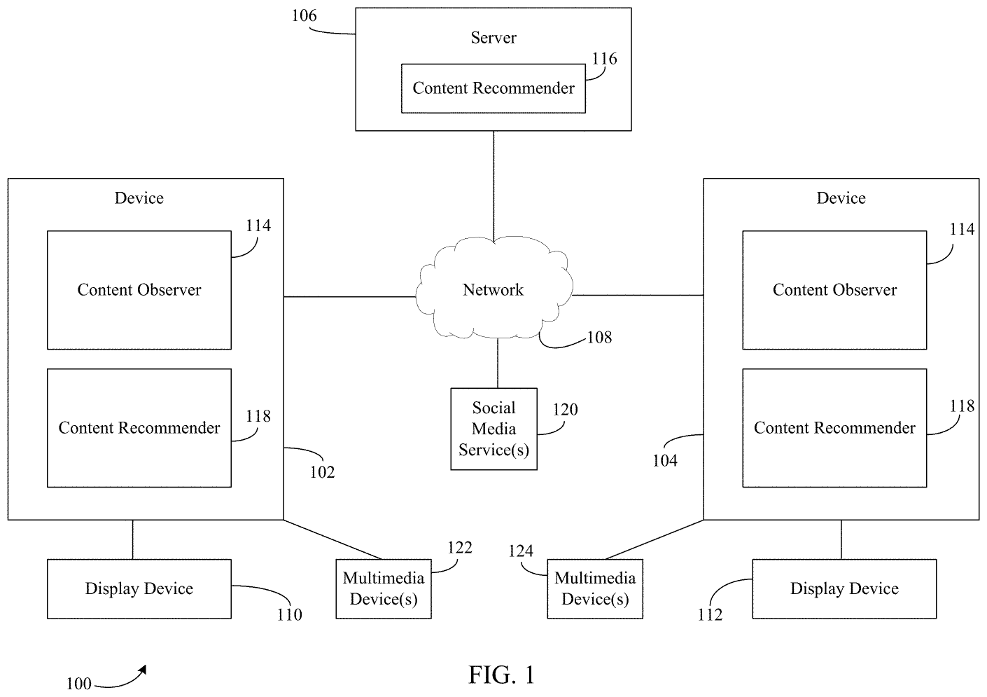

For instance, FIG. 1 shows a block diagram of a system 100 for recommending content based on content being engaged with by a user's social media contacts in accordance with an example embodiment. As shown in FIG. 1, system 100 includes a first device 102, a second device 104, a server 106, and one more social media services 120. First device 102, second device 104, server 106 and social media service(s) 120 are communicatively coupled via a network 108. Network 108 may comprise one or more networks such as local area networks (LANs), wide area networks (WANs), enterprise networks, the Internet, etc., and may include one or more of wired and/or wireless portions. First device 102 and/or second device 104 may be any type of device disclosed herein or a portion thereof, such as, but without limitation, devices via which media and multimedia content may be consumed. For example, first device 102 and/or second device 104 may be, a laptop, a tablet, a smart phone, a set-top box, a gaming console, an AV switching device (e.g., a high-definition multimedia interface (HDMI) switching device), a home networking device, a home entertainment device, any other in-home wireless, content-delivery/streaming devices, a custom device according to embodiments herein, etc. As further shown in FIG. 1, first device 102 is communicatively coupled to a display device 110 (e.g., via an A/V port, such as, but not limited to, an HDMI port), and second device 104 is communicatively coupled to a display device 112 (e.g., via an A/V port, such as, but not limited to, an HDMI port). Display device 110 and/or display device 112 may be a display screen (e.g., an LCD (liquid crystal display), LED (light emitting diode), OLED (organic LED), etc., screen), a monitor, a television, a projector, etc. In accordance with embodiments, display device 110 may be integrated with first device 102, and/or display device 112 may be integrated with second device 104.

As also shown in FIG. 1, each of first device 102 and/or second device 104 may include content observer 114 and/or a content recommender 118. Content observer 114 may be configured to observe/detect the content being engaged (e.g., watched) by the user (e.g., media/multimedia activity consumption). For instance, content observer 114 may determine that a piece of media content is being consumed (e.g., a TV show, a movie, Internet media, a Web series, etc.) via its respective device in which its incorporated (e.g., first device 102 or second device 104). Content observer 114 may determine that a user is engaging in a particular piece of content based on a selection made for that content by the user. For instance, each of first device 102 and second device 104 may be configured to render a graphical user interface (GUI) on its respective display device. The GUI may enable a user to search for and/or select media content for consumption. The media content may be provided via one or more multimedia devices 122 coupled to first device 102 and/or multimedia device(s) 124 coupled to second device 104. Examples of multimedia devices 122 and 124 include, but are not limited to, a satellite set-top box, a cable set-top box, a DVD player, a Blu-ray player, an Internet streaming device (e.g., a Roku, Apple TV, Fire TV, etc.). Upon making a selection for content to watch, content observer 114 may send a communication message to server 106 that identifies the particular piece of media content being engaged by the user (e.g., the title of the show being watched), an identifier of the user (e.g., a first name, a last name, a username, etc.), and/or a temporal identifier that identifies the time, day, date, etc. at which the user is consuming the piece of media content. It is noted that content observer 114 may identify the media content being consumed by the user in other ways, in addition to and/or in lieu of the techniques described above.

Server 106 may include a content recommender 116 that is configured to make recommendations to a user based on the observed/detected media content consumption of other users. In accordance with an embodiment, the users are associated with each other via social media service(s) 120. Examples of social media service(s) 120 include, but are not limited to, Facebook®, Twitter®, etc. Social media service(s) 120 may be implemented via one or computing devices (e.g., servers), software, or a combination thereof. In accordance with such an embodiment, server 106 may be provided with the user credentials of social media service(s) 120 for the users of first device 102 and second device 104. For example, users may log into first device 102 and second device 104, respectively, using their social media user credentials, and such credentials may be provided to server 106. In another example, first device 102 and second device 104 may prompt users to input their social media user credentials, and first device 102 and second device 104 may provide the user credentials to server 106. In yet another example, a user may provide their social media user credentials via a website associated with first device 102 and/or second device 104 and that is maintained by server 106. For instance, users may set-up an online account associated with their respective first device 102 or second device 104. The online account may enable users to set-up a user profile, which includes social media accounts that are associated with the users.

Upon receiving user credentials, server 106 may log into the user's social media account and determine whether that user has contacts (e.g., friends, associates, followers, etc.) that utilize a multimedia device (e.g., first device 102 or second device 104) for consuming content. For example, if the user credentials of a user's contacts have also been provided to server 106, server 106 may determine that the user's contacts also utilize a multimedia device (e.g., first device 102 or second device 104) for consuming content. Server 106 may determine whether a contact is engaging or has engaged in content upon receiving a communication message from that contact's multimedia device that specifies the media content being watched by that user. Alternatively, server 106 may receive communication messages from social media service(s) 120 that specify social media posts from the user's contacts that specify what those contacts are watching. Content recommender 116 may provide a communication message to the user's multimedia device (e.g., first device 102) that identifies the media content being watched by his contact.

Content recommender 118 of the device receiving the communication message (e.g., first device 102 or second device 104) may then cause an identifier to be rendered on display device 110 that recommends the identified media content to the user and/or an identifier of the user engaging with the identified media content (e.g., “Sam is watching the Emmy's, would you like to watch as well?”) via a GUI. Content recommender 118 may, in addition to recommending content, prompt the user to determine whether the user would like to engage in the recommended content, to add the recommended content into a watchlist, and/or record the recommended content. If the user provides a selection indicating that he would like to engage in the content, first device 102 may automatically determine the device and/or streaming application that provides the content and automatically causes the content to be played back (e.g., by launching the content via a streaming application provided by multimedia device(s) 122, changing the channel of multimedia device(s) 122 (e.g., a cable or satellite set-top box, etc.), etc.). In accordance with an embodiment in which first device 102 or second device 102 is an A/V switching device, first device 102 or second device 104 automatically switches to a port of the plurality of AV ports thereof to a multimedia device of multimedia device(s) 122 or 124, respectively that is configured to provide the media content, etc. Additional details regarding an A/V switching device that is configured to automatically determine a source device from which media content may be played back be found in U.S. Pat. No. 10,051,204, which is titled “Seamless Setup and Control for Home Entertainment Devices and Content” and issued on Aug. 14, 2018.

Content recommender 116 may further recommend new episodes for media content based on past viewing/consumption observations for the user's contacts. Recommendations may comprise new shows that will become available for the media content (e.g., or that will be recorded (or have been recorded)) based on periodicity of the media content. Such content may include television content or Web series that are released in a periodic fashion (e.g., once a week). Content recommender 116 may be configured to determine the availability of released or upcoming (to be released) content to be recommended for the user based on his contact's consumption of media content.

Content recommender 116 may utilize the temporal identifier to recommend content to the user that has already been watched by a contact in the past. For example, content recommender 118 may cause an identifier to be rendered that specifies media content that was previously watched by a contact and may prompt the user to determine whether the user would like to engage in the recommended content and/or record the recommended content. The identifier may be displayed at any time while first device 102 is being utilized by the user. For example, the identifier may be displayed upon a determination that the user is browsing for content to watch. In another example, the identifier may be displayed based on a periodicity at which the media content is viewable. For instance, if a contact watched a show that airs every Sunday at 8:00 pm, content recommender 118 may display the identifier at or approximately at 8:00 pm on Sunday (e.g., “James watched Game of Thrones at this time last week. It's about to start, would you like to watch?”).

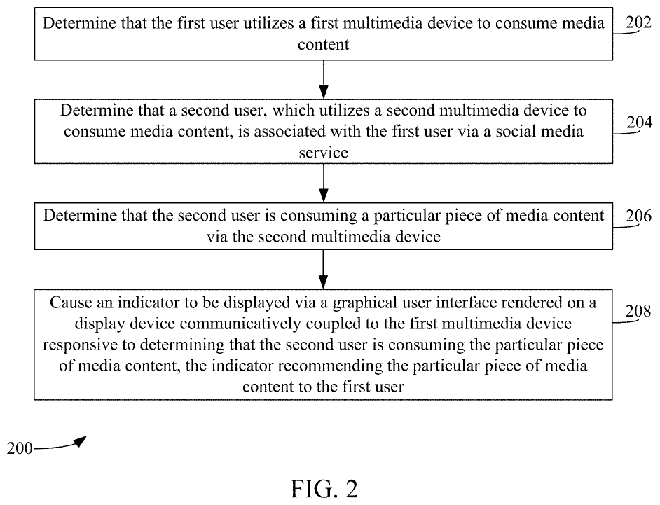

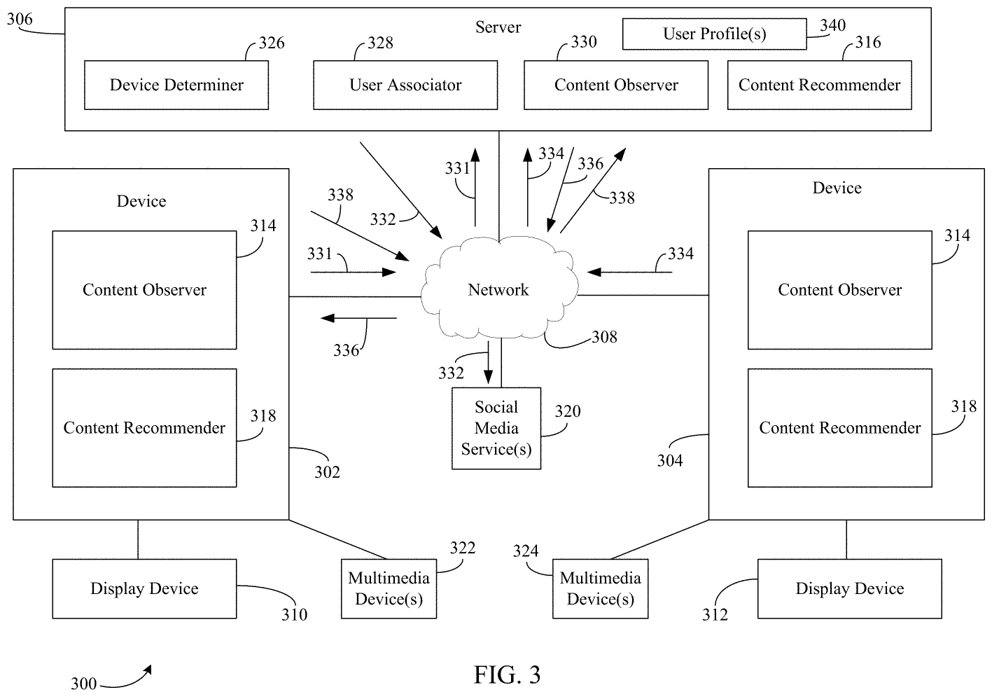

Turning now to FIG. 2, FIG. 2 depicts a flowchart 200 of an example process for recommending content based on content being engaged with by a user's social media contacts, according to an example embodiment. The method of flowchart 200 will now be described with continued reference to FIG. 3, although flowchart 200 is not limited to the implementation depicted therein. FIG. 3 shows a system 300 for recommending content based on content being engaged with by a user's social media contacts in accordance with another example embodiment. As shown in FIG. 3, system 300 includes a first device 302, a second device 304, a server 306, one more social media services 320, a display device 310, a display device 312, multimedia device(s) 320, multimedia device(s) 332. First device 302, second device 304, server 306 and social media service(s) 320 are communicatively coupled via a network 308. First device 302, second device 304, server 306, network 308, social media service(s) 320, display device 310, display device 312, multimedia device(s) 322, and multimedia device(s) 324 are examples of first device 102, second device 104, server 106, network 108, social media service(s) 120, display device 110, display device 112, multimedia device(s) 122, and multimedia device(s) 124, as respectively described above with reference to FIG. 1. As also shown in FIG. 3, server 306 comprises a device determiner 326, a user associator 328, a content observer 330, and a content recommender 316. Content recommender 316 is an example of content recommender 116, as described above with reference to FIG. 1. Each of first device 302 and second device 304 comprises a content observer 314 and a content recommender 318. Content observer 314 and content recommender 318 are examples of content observer 114 and content recommender 118, as respectively described above with reference to FIG. 1. Other structural and operational embodiments will be apparent to persons skilled in the relevant art(s) based on the following discussion regarding flowchart 200 and system 300 of FIG. 3.

Flowchart 200 of FIG. 2 begins with step 202. In step 202, a determination is made that the first user utilizes a first multimedia device to consume content. For example, with reference to FIG. 3, device determiner 326 of server 306 may determine that the first user utilizes first device 302. For example, first device 302 may provide a communication message 331 to device determiner 326 via network 308. Communication message 331 may indicate that first device 302 is powered on and/or being utilized by the user. Communication message 331 may be provided by first device 302 responsive to first device 302 being powered on. Alternatively, communication message 332 may be provided by first device 302 responsive to a user interacting with a graphical user interface provided by first device 302 and that is displayed via display device 110.

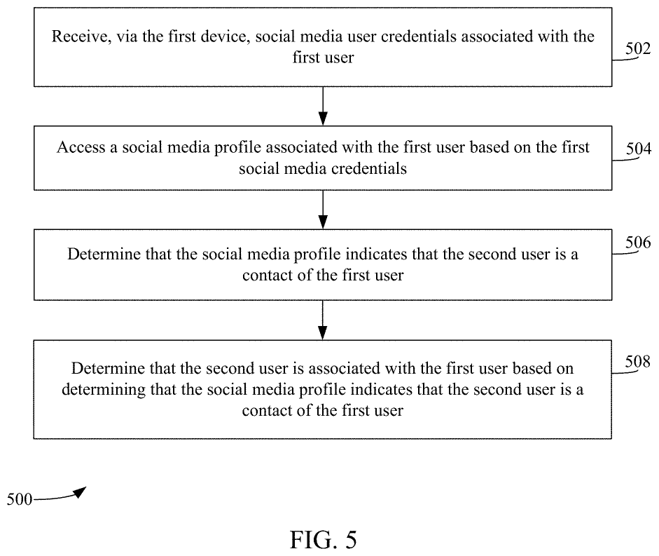

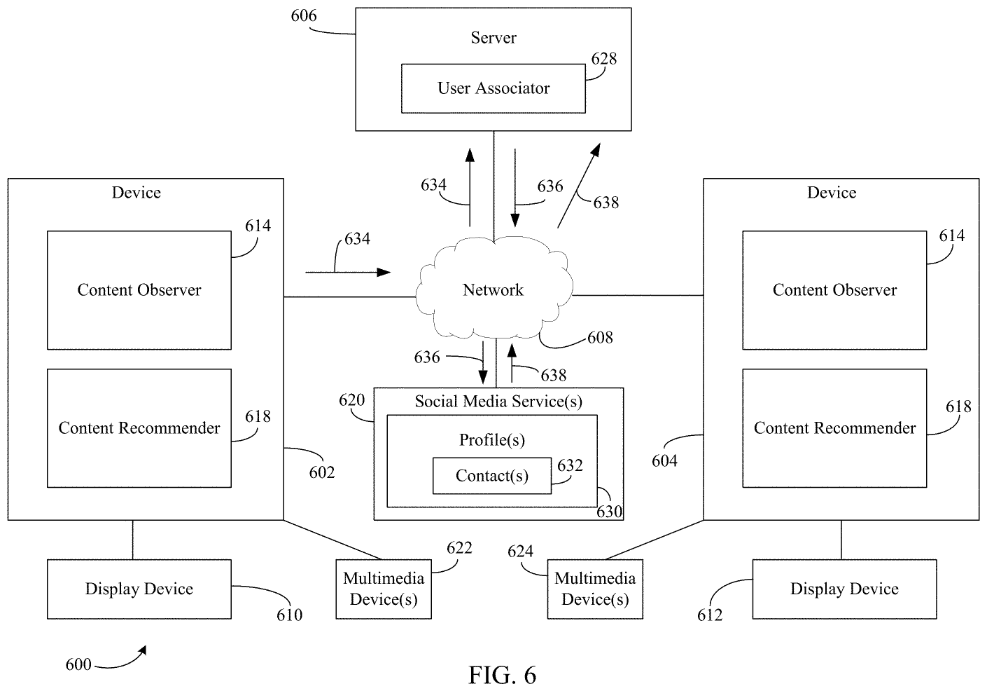

At step 204, a determination is made that a second user, which utilizes a second multimedia device to consume media content, is associated with the first user via a social media service. For example, with reference to FIG. 3, user associator 328 of server 306 may determine that a second user utilizing second device 304 for consuming media content is associated with the first user. For example, user associator 328 may provide a query 332 to social media service(s) 320 to determine whether the second user is associated with the first user. Additional details regarding determining whether users are associated with each other are described below with reference to FIGS. 5 and 6.

At step 206, a determination is made that the second user is consuming a particular piece of media content via the second multimedia device. For example, with reference to FIG. 3, content observer 330 of server 306 may determine that the second user is consuming a particular piece of media content via second device 304.

In accordance with one or more embodiments, a communication message is received from the second device that identifies the particular piece of content. For example, content observer 314 of second device 304 may provide a communication message 334 to content observer 330 via network 308. Communication message 334 may specify the piece of content being watched by the second user via second device 304 and/or an identifier (e.g., first name, last name, username, etc.) of the second user.

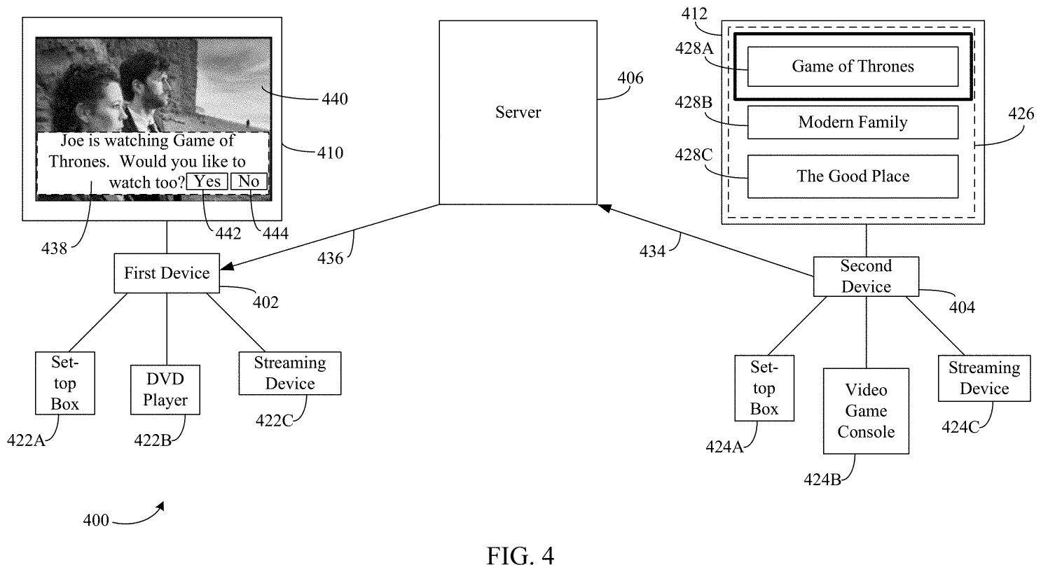

For instance, FIG. 4 shows a system 400 for recommending content based on content being engaged with by a user's social media contacts in accordance with yet another example embodiment. As shown in FIG. 4, system 400 includes a first device 402, a second device 404, a server 406, a display device 410, a display device 412, multimedia devices 422-422C, and multimedia devices 424A-424C. First device 402, second device 404, and server 406 may be communicatively coupled via a network (e.g., network 308). First device 402, second device 404, server 406, display device 410, display device 412, multimedia devices 422A-422C, and multimedia devices 424A-424C are examples of first device 302, second device 304, server 306, display device 310, display device 312, multimedia device(s) 322, and multimedia device(s) 324, as respectively described above with reference to FIG. 3. In the example shown in FIG. 4, first device 402 and first device 404 are audio/video switching devices. Multimedia device 422A may be a satellite set-top box, multimedia device 422B may be a DVD player, multimedia device 422C may be an Internet streaming device, multimedia device 424A may be a cable set-top box, multimedia device 424B may be a video game console, and multimedia device 424C may be an Internet streaming device. It is noted that such multimedia devices are purely exemplary and that multimedia devices 422A-422C and 424A-424C may be other types multimedia devices. Multimedia devices 422A-422C may be coupled to first device 402, and multimedia devices 424A-424C may be coupled to second device 404 via A/V ports (e.g., HDMI ports).

As shown in FIG. 4, a second user may be navigating a GUI 426 being displayed via display device 412. GUI 426 is provided by second device 404 and enables the user to search for media content that is provided via any of multimedia devices 424A-424C. As shown in GUI 426, a plurality of different content item identifiers 428A-428C are being displayed via display device 412, as the user is searching for media content to watch and that is provided by any of multimedia devices 424A-424C. Selection of one of media content identifiers 428A-428C causes the media content identified thereby to be played back via a multimedia device of multimedia devices 424A-424C that is enabled to provide and/or play back the media content. As further shown in FIG. 4A, the user has selected media content identifier 428A (i.e., “Game of Thrones”).

In response to selecting media content identifier 428A, second device 404 may provide a communication message 434 that specifies the media content being played back via second device 404 (e.g., provides an identifier (such as the name) of the media content) to server 406 (e.g., via a network, such as network 308). Additional details regarding switching devices that are enabled to search for content via different content sources is may be found in aforementioned U.S. Pat. No. 10,051,204.

Returning to FIG. 2, at step 208, an indicator is caused to be displayed via a graphical user interface rendered on a display device communicatively coupled to the first multimedia device responsive to determining that the second user consuming the particular piece of media content is associated with the first user, the indicator recommending the particular piece of media content to the first user. For example, with reference to FIG. 3, content recommender 316 of server 306 causes an indicator to be displayed via a GUI rendered on display device 310 coupled to first device 302 that recommends the particular piece of media content. For instance, content recommender 316 may provide a communication message 336 to first device 318 via network 308. Communication message 336 may specify the piece of media content being watched by the second user via second device 304 and an identifier of the second user. Content recommender 318 of first device 302 may cause an indicator to be rendered via display device 310 that informs the user of the media content being watched by the second user along with the identifier of the second user.

For example, with reference to FIG. 4, responsive to receiving communication message 434, server 406 may provide a communication message 436 to first device 402 via a network. Communication message 436 may specify the piece of media content being watched by the second user via second device 404 and/or an identifier of the second user. Communication message 436 is an example of communication message 336 as described above with reference to FIG. 3. In response to receiving communication message 436, first device 404 (e.g., content recommender 318 of first device 304) causes the graphical user interface of first device 402 to display an indicator 438 via display screen 410. As shown in FIG. 4, indicator 438 is overlaid on media content 440 being played back and displayed via display device 410. Indicator 438 may specify an identifier of the media content being watched by the second user and/or an identifier (e.g., first name, last name, username, etc.) of the second user (e.g., “Joe is watching Game of Thrones”). Indicator 438 may further prompt the user if he or she would like to watch the media content being watched by the second user (e.g., “Would you like to watch too?”).

In accordance with one or more embodiments, a user-interactive element is caused to be displayed via the graphical user interface that, when activated, causes the particular piece of media content to be played back via the first device. For example, with reference to FIG. 4, first device 402 may further cause the GUI of first device 402 to display one or more user-interactive elements 442 and 444 via display screen 410. User-interactive element 442, when activated (e.g., via a mouse click, a button press of a remote control device communicatively coupled to first device 402, a touch screen, etc.), may cause first device 402 to play back the media content being recommended via the proper multimedia device of multimedia devices 410A-410C. User-interactive element 444, when activated, may cause first device 402 to stop the displaying of indicator 438 so that the user may continue to watch media content 440 without any interruptions and/or obstructions.

In accordance with an embodiment, communication message 434 may be provided to server 406 based on a determination that the second user has been watching the media content for a predetermined time period (e.g., 5 minutes, 10 minutes, etc.). By doing so, second device 404 provides communications messages 434 when it is likely that the second user is actually watching the media content, rather than sampling media content to determine which media content to watch. This also advantageously prevents the first user from being bombarded with recommendations when the second user is sampling/browsing for media content to watch.

In accordance with one or more embodiments, a determination is made that the first user is browsing for media content to engage via the graphical user interface of the first device, and an indicator is caused to be displayed via the graphical user interface in response to determining that the first user is browsing for the media content. For example, with reference to FIG. 3, content recommender 318 may determine that the user is browsing for media content to engage with via the GUI provided by first device 304. For instance, content recommender 318 may monitor user actions with respect to the GUI (e.g., scrolling, content item searches, etc.) and determine that the user is browsing for media content. In response, content recommender 318 may provide a communication message 338 to server 306 via network 308. Communication message 338 may indicate to content recommender 316 of server 306 that recommendations are to be provided to content recommender 318 of first device 302. In response to receiving communication message 338, content recommender 316 may determine whether a second user associated with the first user is engaging in media content and, if so, provides communication message 336 that specifies the piece of media content being watched by the second user and/or an identifier of the second user. With reference to FIG. 4, first device 402 causes indicator 438 and/or user-interactive elements 440 and 442 to be rendered via the GUI displayed on display device 410 responsive to receiving the communication message (e.g., communication message 336 or 436). The foregoing techniques advantageously provides recommendations to a user only when it is inferred that the user is searching for media content to watch or does not know what media content to watch.

In accordance with one or more embodiments, a determination is made that the second user is consuming the particular piece of media content during at least one of a particular day or a particular time and the indicator is caused to be displayed via the graphical user interfaced rendered on the display device based on the at least one of the particular day or the particular time. For example, with reference to FIG. 3, communication message 334 may further include a temporal identifier that, for example, specifies the day and/or time at which the second user is consuming media content via second device 304. Alternatively, content observer 330 of server 306 may determine the day and/or time based on the day and/or time at which communication message 334 is received by server 306. Server 306 may determine and/or maintain user profiles 340 for users of first device 302 and second device 304. Each user profile of user profiles 340 for a particular user may maintain a history of media content watched by that user and the days and/or times at which each media content is watched.

Content recommender 316 may be configured to provide recommendations for media content via communication message 336 on the day and/or time at which the media content airs. For example, the user profile of user profile(s) 340 of the second user indicates that the second user watches “Modern Family” on Wednesday at 7:00 PM CT, content recommender 316 may provide recommendations to first device 402 on Wednesday at 7:00 PM CT or approximately at (e.g., 5 minutes before) 7:00 PM CT. By doing so, the user will receive recommendations for media content that is available for viewing at or around the time the media content is available for viewing.

Turning now to FIG. 5, FIG. 5 depicts a flowchart 500 of an example process for determining that users are associated with each other via a social media service, according to an example embodiment. The method of flowchart 500 will now be described with reference to FIG. 6, although flowchart 500 is not limited to the implementation depicted therein. FIG. 6 shows a system 600 for determining that users are associated with each other a via social media service, according to an example embodiment. As shown in FIG. 6, system 600 includes a first device 602, a second device 604, a server 606, one or more social media services 620, a display device 610, a display device 612, multimedia device(s) 622, and multimedia device(s) 624. First device 602, second device 604, server 606 and social media service(s) 620 are communicatively coupled via a network 608. First device 602, second device 604, server 606, network 608, social media service(s) 620, display device 610, display device 612, multimedia device(s) 622, and multimedia device(s) 624 are examples of first device 302, second device 304, server 306, network 308, social media service(s) 320, display device 310, display device 312, multimedia device(s) 322, and multimedia device(s) 324, as respectively described above with reference to FIG. 3. As also shown in FIG. 6, server 606 comprises a user associator 628, which is an example of user associator 328, as described above with reference to FIG. 3. Each of first device 602 and second device 604 comprise a content observer 614 and a content recommender 618. Content observer 614 and content recommender 618 are examples of content observer 314 and content recommender 318, as respectively described above with reference to FIG. 3. As further shown in FIG. 6, social media service(s) 620 maintains user profile(s) 630 for user(s) of social media service(s) 620. Each user profile of user profile(s) 630 may maintain a listing of contacts 632 that are associated with a particular user. Other structural and operational embodiments will be apparent to persons skilled in the relevant art(s) based on the following discussion regarding flowchart 500 and system 600 of FIG. 6.

Flowchart 500 of FIG. 5 begins with step 502. In step 502, social media user credentials associated with the first user are received via the first device. For example, with reference to FIG. 6, first device 602 provides a communication message 634 to server 606 via network 608. Communication message 634 specifies social media user credentials of the first user. In accordance with an embodiment, first device 602 may receive social media user credentials from the user. For example, users may log into first device 602 using their social media user credentials. In another example, first device 602 may prompt users, via a GUI, to input their social media user credentials.

In step 504, a social media profile associated with the first user is accessed based on the social media user credentials. For example, with reference to FIG. 6, user associator 628 may access a user profile of user profile(s) 630 that is associated with the first user using the social media user credentials. For instance, user associator 628 may provide a query 636 to social media service(s) 620. Query 636 may specify the social media user credentials and/or may be configured to query a listing of social media contacts 632 of a user profile of user profile(s) 632 associated with the first user. Responsive to receiving query 636, social media service(s) 620 may provide contacts 632 that are associated with the first user to server 606 via a response 638.

In step 506, a determination is made that the social media profile indicates that the second user is a contact of the first user. For example, with reference to FIG. 6, user associator 628 determines that contacts 632 maintained by the first user's profile of user profile(s) 630 indicates that the second user (i.e., the user of second device 604) is a contact of the first user.

In step 508, a determination is made that the second user is associated with the first user based on determining that the social media profile indicates that the second user is a contact of the first user. For example, with reference to FIG. 6, user associator 628 determines that the second user is associated with the first user based on determining that contacts 632 maintained by the first user's profile of user profile(s) 630 indicates that the second user (i.e., the user of second device 604) is a contact of the first user.

Accordingly, server 606 may be configured to track the media content that is being watched by the contacts of the first user and make content recommendations based on the viewing habits of the first user's contacts.

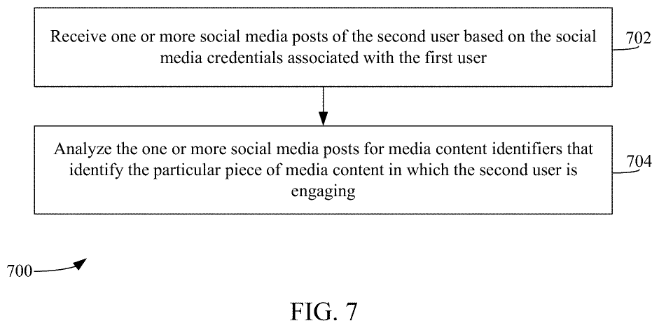

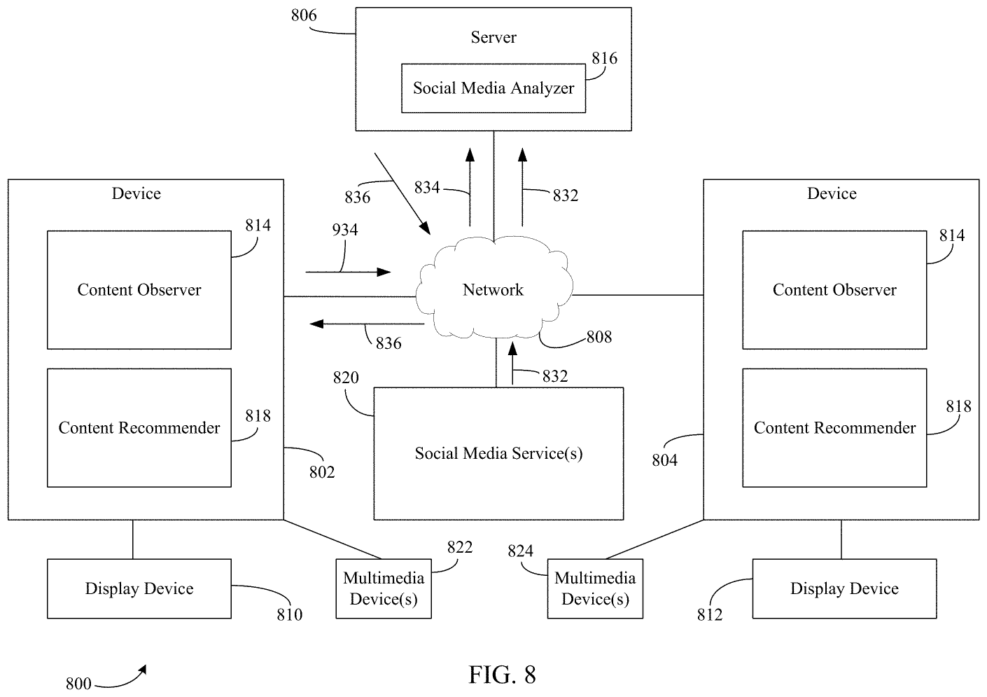

Turning now to FIG. 7, FIG. 7 depicts a flowchart 700 of an example process for determining a particular piece of media content in which a user is engaging via a social media service, according to an example embodiment. The method of flowchart 700 will now be described with reference to FIG. 8, although flowchart 700 is not limited to the implementation depicted therein. FIG. 8 shows a system 800 for determining a particular piece of media content in which a user is engaging via a social media service, according to an example embodiment. As shown in FIG. 8, system 800 includes a first device 802, a second device 804, a server 806, one or more social media services 820, a display device 810, a display device 812, multimedia device(s) 822, and multimedia device(s) 824. First device 802, second device 804, server 806 and social media service(s) 820 are communicatively coupled via a network 808. First device 802, second device 804, server 806, network 808, social media service(s) 820, display device 810, display device 812, multimedia device(s) 822, and multimedia device(s) 824 are examples of first device 602, second device 604, server 606, network 608, social media service(s) 620, display device 610, display device 612, multimedia device(s) 622, and multimedia device(s) 624, as respectively described above with reference to FIG. 6. As also shown in FIG. 8, server 306 comprises a social media analyzer 816. Each of first device 802 and second device 804 comprise a content observer 814 and a content recommender 818. Content observer 814 and content recommender 818 are examples of content observer 614 and content recommender 618, as respectively described above with reference to FIG. 6. Other structural and operational embodiments will be apparent to persons skilled in the relevant art(s) based on the following discussion regarding flowchart 700 and system 800 of FIG. 8.

Flowchart 700 of FIG. 7 begins with step 702. In step 702, one or more social media posts of the second user are received based on the social media credentials associated with the first user. For example, with reference to FIG. 8, social media analyzer 816 of server 806 may be configured to receive communication messages (e.g., push notifications) from social media service(s) associated with the first user. For example, social media analyzer 816 may receive social media user credentials from first device 804 via a communication message 834. Communication message 834 is an example of communication message 634, as described above with reference to FIG. 6. Social media analyzer 816 may be configured to access the first user's social media account(s) maintained social media service(s) 820 and configure social media service(s) 820 to provide communication message(s) 832 to server 806 via network 808. Communication message(s) 832 may comprise social media posts of the second user (i.e., the user of second device 804) that are, for example, posted on an activity feed of the first user. Communication message(s) 832 may further comprise an identifier of the second user. The activity feed comprises social media posts that are made by contacts (e.g., second user) of the first user, along with other information, such, but not limited, certain activity of the contacts (e.g., “likes,” “dislikes,” “check-ins,” etc.).

In step 704, the one or more social media posts are analyzed for media content identifiers that identify the particular piece of media content in which the second user is engaging. For example, with reference to FIG. 8, social media analyzer 816 may analyze social media posts received via communication messages 832 for social media identifiers that identify the particular piece of media content in which the second user is engaging. Server 806 may be configured to recommend the determined media content in which the second user is engaging via a communication message 836, which is provided to first device 802 via network 808. Communication message 836 is an example of communication message 336, as described above with reference to FIG. 3.

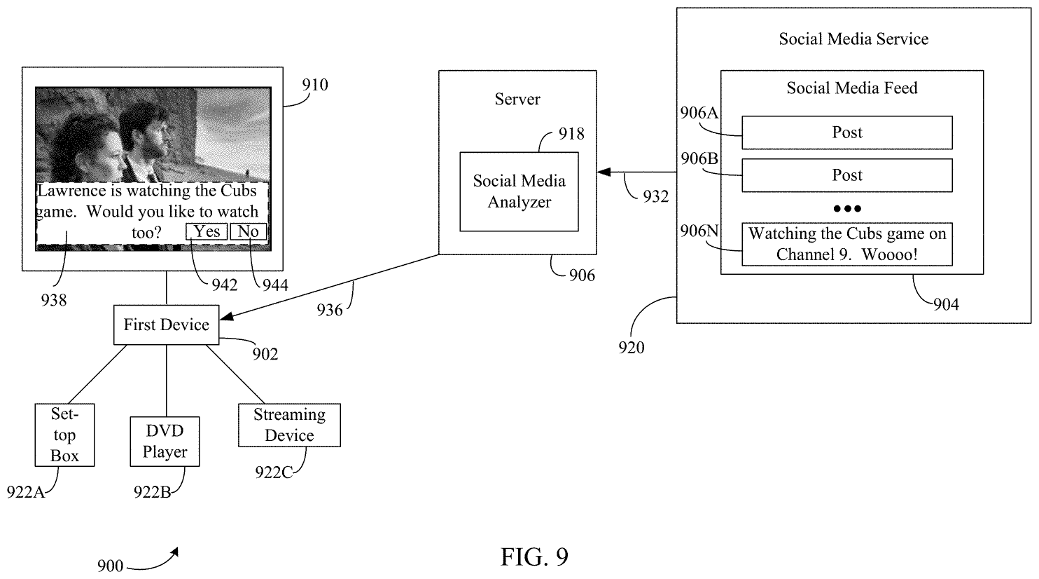

For instance, FIG. 9 shows a system for determining a particular piece of media content in which a user is engaging via a social media service, according to another example embodiment. As shown in FIG. 9, system 900 includes a first device 902, a server 906, a display device 910, multimedia devices 922A-922C, and a social media service 920. First device 902, server 906, and social media service 920 may be communicatively coupled via a network (e.g., network 808). First device 902, server 906, display device 910, multimedia devices 922A-922C, and social media service 920 are examples of first device 802, server 806, display device 810, multimedia device(s) 822, and social media service(s) 820, as respectively described above with reference to FIG. 8. In the example shown in FIG. 9, first device 902 is an audio/video switching device. Multimedia device 922A may be a satellite set-top box, multimedia device 922B may be a DVD player, and multimedia device 922C may be an Internet streaming device. It is noted that such multimedia devices are purely exemplary and that multimedia devices 922A-922C may be other types multimedia devices. Multimedia devices 922A-922C may be coupled to first device 902, and multimedia devices via A/V ports (e.g., HDMI ports). As also shown in FIG. 9, social media service 920 comprises a social media feed 904 of the first user that comprises a plurality of social media posts 906A-906N. Social media posts 906A-906N may comprise posts of contacts associated with first user (e.g., the second user). Social media service 920 may be configured to provide a communication message 932 to server 906 (e.g., via a network 808) each time a post is posted to social media feed 904. Communication message 932 is an example of communication message 832, as described above with reference to FIG. 8.

Social media analyzer 918 of server 906 may be configured to analyze each social media post received via communication message(s) 932 to determine media content identifiers included therein. For example, responsive to receiving a communication message 932 corresponding to post 906N, social media analyzer 918 may determine that the second user (named “Lawrence”) is watching the Cubs game. Social media analyzer 918 may utilize natural language processing (NLP)-based techniques and/or other techniques to identify media content identifiers, although the embodiments described herein are not so limited. In response to determining that the second user is watching the Cubs game, server 906 may provide a communication message 936 specifies the piece of media content being watched by the second user and an identifier of the second user. Communication message 936 is an example of communication message 336, as described above with reference to FIG. 3. In response to receiving communication message 336, first device 902 (e.g., content recommender 318 of first device 304) causes the graphical user interface of first device 902 to display an indicator 938 via display screen 910. As shown in FIG. 9, indicator 938 is overlaid on media content 940 being played back and displayed via display device 910. Indicator 938 may specify an identifier of the media content being watched by the second user and/or an identifier (e.g., first name, last name, username, etc.) of the second user (e.g., “Lawrence is watching the Cubs game.”). Indicator 938 may further prompt the user if he or she would like to watch the media content being watched by the second user (e.g., “Would you like to watch too?”).

In accordance with one or more embodiments, a user-interactive element is caused to be displayed via the graphical user interface that, when activated, causes the particular piece of media content to be played back via the first device. For example, with reference to FIG. 9, first device 902 may further cause the GUI of first device 902 to display one or more user-interactive elements 942 and 944 via display screen 910. User-interactive element 942, when activated (e.g., via a mouse click, a button press of a remote control device communicatively coupled to first device 902, a touch screen, etc.), may cause first device 902 to play back the media content being recommended via the proper multimedia device of multimedia devices 910A-910C. User-interactive element 944, when activated, may cause first device 902 to stop the displaying of indicator 938 so that the user may continue to watch media content 940.

### IV. Further Example Embodiments and Advantages

It should be noted that embodiments are contemplated for different types of media and multimedia content and activities, and while some embodiments described above refer to television or media content, embodiments are not so limited. Embodiments contemplate, without limitation, all forms of streaming media and multimedia content, rentable and pay-per-view content, content from satellite providers, content from internet service/application providers, and/or the like.

It is noted that certain components of server 106 may be incorporated in devices 102 and 104, and vice versa. For example, content recommender 116 may be implemented in devices 102 and 104 and/or content observer 114 and content recommender 118 may be implemented in server 106. It is also noted that certain components of server 306 may be incorporated in devices 302 and 304, and vice versa. For example, content recommender 316, device determiner 326, user associator 328, content observer 330, and user profile(s) 340 may be implemented in devices 302 and 304 and/or content observer 314 and content recommender 318 may be implemented in server 306. It is further noted that certain components of server 606 may be incorporated in devices 602 and 604, and vice versa. For example, user associator 628 may be implemented in devices 602 and 604 and/or content observer 614 and content recommender 618 may be implemented in server 606. It is also noted that certain components of server 806 may be incorporated in devices 802 and 804, and vice versa. For example, social media analyzer 816 may be implemented in devices 802 and 804 and/or content observer 814 and content recommender 818 may be implemented in server 806. It is further noted that certain components of server 906 may be incorporated in device 902, and vice versa. For example, social media analyzer 916 may be implemented in device 902.

In embodiments, one or more of the operations of any flowchart described herein may not be performed. Moreover, operations in addition to or in lieu of any flowchart described herein may be performed. Further, in embodiments, one or more operations of any flowchart described herein may be performed out of order, in an alternate sequence, or partially (or completely) concurrently with each other or with any other operations.

### V. Example Computer Implementations

A device, as defined herein, is a machine or manufacture as defined by 35 U.S.C. § 101. Devices may be digital, analog or a combination thereof. Devices may include integrated circuits (ICs), one or more processors (e.g., central processing units (CPUs), microprocessors, digital signal processors (DSPs), etc.) and/or may be implemented with any semiconductor technology, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

Techniques and embodiments, including methods, described herein may be implemented in hardware (digital and/or analog) or a combination of hardware and software and/or firmware. Techniques described herein may be implemented in one or more components. Embodiments may comprise computer program products comprising logic (e.g., in the form of program code or instructions as well as firmware) stored on any computer useable storage medium, which may be integrated in or separate from other components. Such program code, when executed in one or more processors, causes a device to operate as described herein. Devices in which embodiments may be implemented may include storage, such as storage drives, memory devices, and further types of computer-readable media. Examples of such computer-readable storage media include, but are not limited to, a hard disk, a removable magnetic disk, a removable optical disk, flash memory cards, digital video disks, random access memories (RAMs), read only memories (ROM), and the like. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may, for example, store computer program logic, e.g., program modules, comprising computer executable instructions that, when executed, provide and/or maintain one or more aspects of functionality described herein with reference to the figures, as well as any and all components, steps and functions therein and/or further embodiments described herein.

Computer readable storage media are distinguished from and non-overlapping with communication media (do not include communication media or modulated data signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wired media as well as wireless media such as acoustic, RF, infrared and other wireless media. Example embodiments are also directed to such communication media.

The content recommendation embodiments and/or any further systems, sub-systems, and/or components disclosed herein may be implemented in hardware (e.g., hardware logic/electrical circuitry), or any combination of hardware with software (computer program code configured to be executed in one or more processors or processing devices) and/or firmware.

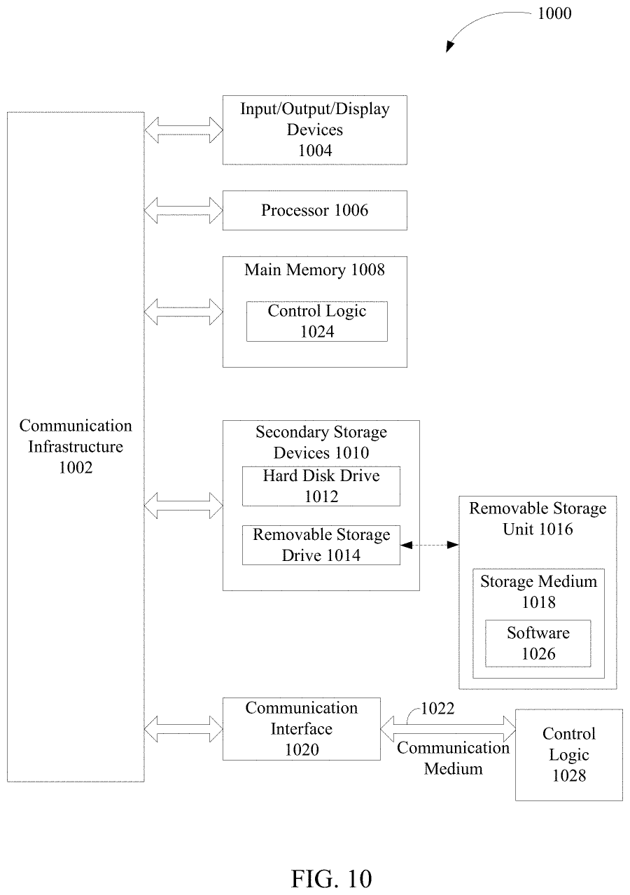

The embodiments described herein, including systems, methods/processes, and/or apparatuses, may be implemented using well known processing devices, servers, electronic devices (e.g., consumer electronic devices) and/or, computers, such as a computer 900 shown in FIG. 10. It should be noted that computer 1000 may represent communication devices, processing devices, servers, and/or traditional computers in one or more embodiments. For example, first device 102, second device 104, and server 106, display device 110, display device 112, content observer 114, content recommender 116, content recommender 118, multimedia device(s) 122, multimedia device(s) 124, and social media service(s) 120, (as described above in reference to FIG. 1), first device 302, second device 304, server 306, display device 310, display device 312, multimedia device(s) 322, multimedia device(s) 324, social media service(s) 320, content observer 314, content recommender 316, and content recommender 318, device determiner 326, user associator 328, content observer 330, and user profile(s) 340 (as described above in reference to FIG. 3), first device 402, second device 404, server 406, display device 410, multimedia device(s) 422A-422C, and multimedia device(s) 424A-424C (as described above in reference to FIG. 4), first device 602, second device 604, server 606, display device 610, display device 612, multimedia device(s) 622A-622C, multimedia device(s) 624A-624C, social media service(s) 620, and user associator 628 (as described above in reference to FIG. 6), first device 802, second device 804, server 806, display device 810, display device 812, multimedia device(s) 822A-822C, multimedia device(s) 824A-824C, social media service 820, and social media analyzer 816 (as described above in reference to FIG. 8), and first device 902, server 906, display device 910, multimedia device(s) 922A-922C, social media service 920, and social media analyzer 918 (as described above in reference to FIG. 9), any of the sub-systems, components or sub-components respectively contained therein, and/or flowcharts 200, 500, and/or 700 may be implemented using one or more computers 1000.

Computer 1000 can be any commercially available and well-known communication device, processing device, and/or computer capable of performing the functions described herein, such as devices/computers available from International Business Machines®, Apple®, Sun®, HP®, Dell®, Cray®, Samsung®, Nokia®, etc. Computer 1000 may be any type of computer, including a desktop computer, a server, etc.

Computer 1000 includes one or more processors (also called central processing units, or CPUs), such as a processor 1006. Processor 1006 is connected to a communication infrastructure 1002, such as a communication bus. In some embodiments, processor 1006 can simultaneously operate multiple computing threads.

Computer 1000 also includes a primary or main memory 1008, such as random access memory (RAM). Main memory 1008 has stored therein control logic 1024 (computer software), and data.

Computer 1000 also includes one or more secondary storage devices 1010. Secondary storage devices 1010 include, for example, a hard disk drive 1012 and/or a removable storage device or drive 1014, as well as other types of storage devices, such as memory cards and memory sticks. For instance, computer 1000 may include an industry standard interface, such a universal serial bus (USB) interface for interfacing with devices such as a memory stick. Removable storage drive 1014 represents a floppy disk drive, a magnetic tape drive, a compact disk drive, an optical storage device, tape backup, etc.

Removable storage drive 1014 interacts with a removable storage unit 1016. Removable storage unit 1016 includes a computer useable or readable storage medium 1018 having stored therein computer software 1026 (control logic) and/or data. Removable storage unit 1016 represents a floppy disk, magnetic tape, compact disk, DVD, optical storage disk, or any other computer data storage device. Removable storage drive 1014 reads from and/or writes to removable storage unit 1016 in a well-known manner.

Computer 1000 also includes input/output/display devices 1004, such as touchscreens, LED and LCD displays, monitors, keyboards, pointing devices, etc.

Computer 1000 further includes a communication or network interface 1018. Communication interface 1020 enables computer 1000 to communicate with remote devices. For example, communication interface 1020 allows computer 1000 to communicate over communication networks or mediums 1022 (representing a form of a computer useable or readable medium), such as LANs, WANs, the Internet, etc. Network interface 1020 may interface with remote sites or networks via wired or wireless connections.

Control logic 1028 may be transmitted to and from computer 1000 via the communication medium 1022.

Any apparatus or manufacture comprising a computer useable or readable medium having control logic (software) stored therein is referred to herein as a computer program product or program storage device. This includes, but is not limited to, computer 1000, main memory 1008, secondary storage devices 1010, and removable storage unit 1016. Such computer program products, having control logic stored therein that, when executed by one or more data processing devices, cause such data processing devices to operate as described herein, represent embodiments of the invention.

Any apparatus or manufacture comprising a computer useable or readable medium having control logic (software) stored therein is referred to herein as a computer program product or program storage device. This includes, but is not limited to, a computer, computer main memory, secondary storage devices, and removable storage units. Such computer program products, having control logic stored therein that, when executed by one or more data processing devices, cause such data processing devices to operate as described herein, represent embodiments of the inventive techniques described herein

### VI. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method for recommending content to a user, comprising:
determining that a first user, which utilizes a first multimedia device to consume media content, is associated with a second user
determining that the first user is engaging with a particular piece of media content via the first multimedia device;
determining that the second user utilizes a second multimedia device to consume media content; and
generating an indicator displayed on a graphical user interface rendered on a display device communicatively coupled to the first multimedia device, wherein the indicator is based on user information associated with the first user and the media content, and, when activated, enables the second user to receive a prompt to consume the particular piece of media content being engaged with by the first user.

2. The method of claim 1, wherein determining that the first user is associated with a second user comprises:
receiving, via the first multimedia device, credential information associated with the first user; and
determining that a user profile associated with the first user indicates that the second user is a contact of the first user.

3. The method of claim 1, wherein generating an indicator further comprises:
determining that the first user is browsing for media content to engage via the graphical user interface of the first multimedia device; and
causing the indicator to be displayed via the graphical user interface in response to determining that the first user is browsing for the media content.

4. The method of claim 1, further comprising causing a user-interactive element to be displayed via the graphical user interface that is configured to cause the particular piece of media content to be played back via the second multimedia device.

5. The method of claim 1, wherein the second multimedia device comprises one of:
a laptop;
a tablet; or
a smart phone.

6. The method of claim 1, wherein determining that the first user is engaging with the particular piece of media content via the first multimedia device comprises:
receiving a communication message from the first multimedia device that identifies the particular piece of media content.

7. The method of claim 1, wherein the indicator, when activated, causes the particular piece of media content to be played back via the first multimedia device.

8. A system, comprising:
at least one processor circuit; and
at least one memory that stores program code configured to be executed by the at least one processor circuit, the program code, when executed by the at least one processor circuit, being configured to perform operations, the operations comprising:
determining that a first user, which utilizes a first multimedia device to consume media content, is associated with a second user
determining that the first user is engaging with a particular piece of media content via the first multimedia device;
determining that the second user utilizes a second multimedia device to consume media content; and
generating an indicator displayed on a graphical user interface rendered on a display device communicatively coupled to the first multimedia device, wherein the indicator is based on user information associated with the first user and the media content, and, when activated, enables the second user to receive a prompt to consume the particular piece of media content being engaged with by the first user.

9. The system of claim 8, wherein determining that the first user is associated with a second user comprises:
receiving, via the first multimedia device, credential information associated with the first user; and
determining that a user profile associated with the first user indicates that the second user is a contact of the first user.

10. The system of claim 8, wherein generating an indicator further comprises:
determining that the first user is browsing for media content to engage via the graphical user interface of the first multimedia device; and
causing the indicator to be displayed via the graphical user interface in response to determining that the first user is browsing for the media content.

11. The system of claim 8, further comprising causing a user-interactive element to be displayed via the graphical user interface that is configured to cause the particular piece of media content to be played back via the second multimedia device.

12. The system of claim 8, wherein the second multimedia device comprises one of:
a laptop;
a tablet; or
a smart phone.

13. The system of claim 8, wherein determining that the first user is engaging with the particular piece of media content via the first multimedia device comprises:
receiving a communication message from the first multimedia device that identifies the particular piece of media content.

14. The system of claim 8, wherein the indicator, when activated, causes the particular piece of media content to be played back via the first multimedia device.

15. A computer-readable storage medium having program instructions recorded thereon that, when executed by at least one processor of a computing device, perform a method, the method comprising:
determining that a first user, which utilizes a first multimedia device to consume media content, is associated with a second user
determining that the first user is engaging with a particular piece of media content via the first multimedia device;
determining that the second user utilizes a second multimedia device to consume media content; and
generating an indicator displayed on a graphical user interface rendered on a display device communicatively coupled to the first multimedia device, wherein the indicator is based on user information associated with the first user and the media content, and, when activated, enables the second user to receive a prompt to consume the particular piece of media content being engaged with by the first user.

16. The computer-readable storage medium of claim 15, wherein determining that the first user is associated with a second user comprises:
receiving, via the first multimedia device, credential information associated with the first user; and
determining that a user profile associated with the first user indicates that the second user is a contact of the first user.

17. The computer-readable storage medium of claim 15, wherein generating an indicator further comprises:
determining that the first user is browsing for media content to engage via the graphical user interface of the first multimedia device; and
causing the indicator to be displayed via the graphical user interface in response to determining that the first user is browsing for the media content.

18. The computer-readable storage medium of claim 15, further comprising causing a user-interactive element to be displayed via the graphical user interface that is configured to cause the particular piece of media content to be played back via the second multimedia device.

19. The computer-readable storage medium of claim 15, wherein the second multimedia device comprises one of:
a laptop;
a tablet; or
a smart phone.

20. The computer-readable storage medium of claim 15, wherein determining that the first user is engaging with the particular piece of media content via the first multimedia device comprises:
receiving a communication message from the first multimedia device that identifies the particular piece of media content.
